(19) United States
(12) Patent Application Publication
(10) Pub. No.: US 2024/0046407 A1
(43) Pub. Date: Feb. 8, 2024

(54) METHOD AND APPARATUS WITH IMAGE RECONSTRUCTION

(71) Applicant: SAMSUNG ELECTRONICS CO., LTD., Suwon-si (KR)

(72) Inventor: INWOO HA, Suwon-si (KR)

(73) Assignee: SAMSUNG ELECTRONICS CO., LTD., Suwon-si (KR)

(21) Appl. No.: 18/102,265

(22) Filed: Jan. 27, 2023

(30) Foreign Application Priority Data
Aug. 3, 2022 (KR) 10-2022-0096814

(51) Int. Cl. G06T 3/00; G06T 5/50

(52) U.S. Cl. CPC G06T 3/0093; G06T 5/50; G06T 2207/20084; G06T 2207/20224

(57) ABSTRACT

An image reconstruction method and apparatus are provided. An image reconstruction method includes determining an image warping result by warping a previous reconstruction result using change-data corresponding to a difference between rendered images, determining a previous filter kernel by executing a first neural network model with a previous rendered image and the image warping result, estimating a current filter kernel by warping the previous filter kernel using the change-data, and determining a current reconstruction result by executing a second neural network model with a current rendered image, the current filter kernel, and the image warping result.

### CROSS-REFERENCE TO RELATED APPLICATIONS

This application claims the benefit under 35 USC § 119(a) of Korean Patent Application No. 10-2022-0096814, filed on Aug. 3, 2022, in the Korean Intellectual Property Office, the entire disclosure of which is incorporated herein by reference for all purposes.

### BACKGROUND

### 1. Field

The following description relates a method and apparatus with image reconstruction.

### 2. Description of Related Art

Image reconstruction may improve image quality through reconstruction of image pixels. Image reconstruction may include supersampling. Supersampling is one of the antialiasing techniques and may remove or soften a boundary between pixels shaped like stairs (“jaggies”). Computer graphic images may be smoothed through supersampling. Recently, neural networks may be used for recent image reconstruction. A neural network may be trained based on deep learning and then perform inference for a desired purpose by mapping input data and output data that are in a nonlinear relationship to each other. Such a trained capability of generating the mapping may be referred to as a learning ability of the neural network. A neural network trained for a special purpose, such as image restoration, may have an ability to generate a relatively accurate output in response to an input pattern that it has not been specifically trained to recognize.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an image reconstruction method includes determining an image warping result by warping a previous reconstruction result using change-data corresponding to a difference between rendered images, determining a previous filter kernel by executing a first neural network model with a previous rendered image and the image warping result, estimating a current filter kernel by warping the previous filter kernel using the change-data, and determining a current reconstruction result by executing a second neural network model with a current rendered image, the current filter kernel, and the image warping result.

The determining of the image warping result may include determining a first image warping result by warping a second previous reconstruction result reconstructed from a second previous rendered image using first change-data corresponding to a difference between a first previous rendered image and the second previous rendered image, and determining a current image warping result by warping a first previous reconstruction result reconstructed from the first previous rendered image using current change-data corresponding to a difference between a current rendered image and the first previous rendered image, wherein the first previous rendered image corresponds to a previous frame of the current rendered image and the second previous rendered image corresponds to a previous frame of the first previous rendered image.

The determining of the previous filter kernel may include executing the first neural network model with the previous rendered image and the first image warping result.

The determining of the current reconstruction result may include executing the second neural network model with the current rendered image, the current filter kernel, and the current image warping result.

The determining of the previous filter kernel by executing the first neural network model may be performed by a first processing unit, and the determining of the current reconstruction result by executing the second neural network model may be performed by a second processing unit.

The determining of the image warping result and the estimating of the current filter kernel may be further performed by the first processing unit.

The first processing unit may be configured to determine the previous filter kernel by executing the first neural network model independent of whether the current rendered image is generated.

The previous rendered image may be a first previous rendered image corresponding to a previous frame of the current rendered image or a second previous rendered image corresponding to a previous frame of the first previous rendered image, the previous reconstruction result may be a first previous reconstruction result reconstructed from the first previous rendered image or a second previous reconstruction result reconstructed from the second previous rendered image, and the first processing unit may be configured to determine the previous filter kernel by executing the first neural network model based on the previous rendered image and the second previous reconstruction result, independent of whether the current rendered image and the first previous reconstruction result are generated.

When a condition for generating a filter is not satisfied, the determining of the previous filter kernel is omitted, and the estimating of the current filter kernel may include estimating the current filter kernel by warping an existing filter kernel used prior to the previous filter kernel, instead of warping the previous filter kernel.

When a condition for generating a filter is not satisfied, the determining of the previous filter kernel may include determining a partial filter kernel of a target region of the previous filter kernel by executing the first neural network model with the previous rendered image and the image warping result, and the estimating of the current filter kernel may include updating a region corresponding to an existing filter kernel used prior to the previous filter kernel as the partial filter kernel of the previous filter kernel, warping the existing filter kernel, and estimating the current filter kernel.

The previous filter kernel may include sub-regions, and the target region may be sequentially selected from among the sub-regions.

The first neural network model may include an auto-encoder model including an encoding block and a decoding block.

The decoding block may include a convolutional recurrent layer configured to determine a current feature based on a previous feature.

The convolutional recurrent layer may warp the previous feature using the change-data and may determine the current feature based on a warping result.

A non-transitory computer-readable storage medium may store instructions that, when executed by a processor, cause the processor to perform any of the methods.

In one general aspect, an image processing apparatus includes a first image processing unit configured to warp a previous reconstruction result using change-data according to a difference between rendered images, and configured to determine an image warping result; and a second processing unit configured to determine a previous filter kernel by executing a first neural network model with a previous rendered image and the image warping result, wherein the first processing unit is configured to estimate a current filter kernel by warping the previous filter kernel using the change-data, and is configured to determine a current reconstruction result by executing a second neural network model with a current rendered image, the current filter kernel, and the image warping result.

The previous rendered image may include a first previous rendered image corresponding to a previous frame of the current rendered image or a second previous rendered image corresponding to a previous frame of the first previous rendered image, the previous reconstruction result may include a first previous reconstruction result reconstructed from the first previous rendered image or a second previous reconstruction result reconstructed from the second previous rendered image, and the first processing unit may be configured to determine the previous filter kernel by executing the first neural network model based on the previous rendered image and the second previous reconstruction result, independent of whether the current rendered image and the first previous reconstruction result are generated.

When a condition for generating a filter is not satisfied, the second processing unit may omit the determining of the previous filter kernel, and the first processing unit may estimate the current filter kernel by warping an existing filter kernel used prior to the previous filter kernel, instead of warping the previous filter kernel.

The first neural network model may correspond to an auto-encoder model including an encoding block and a decoding block, and the decoding block may include a convolutional recurrent layer configured to determine a current feature based on a previous feature.

The convolutional recurrent layer may be configured to warp the previous feature using the change-data, and may be configured to determine the current feature based on a warping result.

Other features and aspects will be apparent from the following detailed description, the drawings, and the claims.

### BRIEF DESCRIPTION OF THE DRAWINGS

FIG. 1 illustrates an example of operations related to image reconstruction, according to one or more embodiments.

FIG. 2 illustrates an example of image reconstruction operations using neural network models, according to one or more embodiments.

FIG. 3 illustrates an example of distributed processing of processing units, according to one or more embodiments.

FIG. 4 illustrates an example of operations related to conditional generation of a filter kernel, according to one or more embodiments.

FIG. 5 illustrates an example of a partial update of a filter kernel, according to one or more embodiments.

FIG. 6 illustrates an example of image reconstruction operations using a first neural network model including a convolutional recurrent layer, according to one or more embodiments.

FIG. 7 illustrates an example of a neural network, according to one or more embodiments.

FIG. 8 illustrates an example of an operation of a recurrent layer, according to one or more embodiments.

FIG. 9 illustrates an example configuration of a recurrent layer, according to one or more embodiments.

FIG. 10 illustrates an example of an image processing method, according to one or more embodiments.

FIG. 11 illustrates an example configuration of an image reconstruction apparatus, according to one or more embodiments.

FIG. 12 illustrates an configuration of an electronic device, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

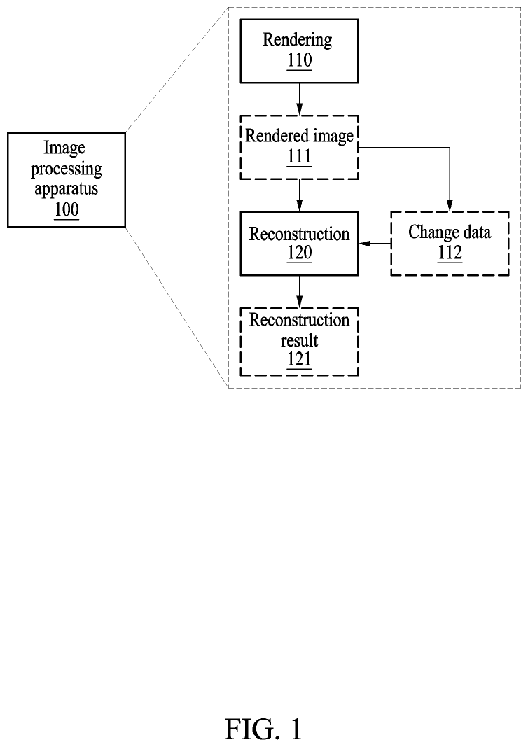

FIG. 1 illustrates an example of operations related to image reconstruction, according to one or more embodiments. Referring to FIG. 1, an image processing apparatus 100 may generate a rendered image 111 through rendering 110. The image processing apparatus 100 may generate the rendered image 111 to represent a specific scene by using computer graphics technology. For example, the image processing apparatus 100 may generate the rendered image 111 through a rendering pipeline. For example, the rendered image 111 may be a game image, an augmented reality (AR) image, a virtual reality (VR) image, or the like. The rendered image 111 may include a plurality of image frames.

The image processing apparatus 100 may generate a reconstruction result 121 by reconstructing the rendered image 111 through a reconstruction operation 120. Resolution of the rendered image 111 may be increased by the reconstruction operation 120. The rendered image 111 may correspond to a relatively low-resolution image compared to the reconstruction result 121, and the reconstruction result 121 may correspond to a relatively high-resolution image compared to the rendered image 111. For example, in the reconstruction operation 120, image reconstruction may include supersampling. Supersampling is one of various antialiasing techniques and may remove a boundary of pixels shaped like stairs, i.e., may smooth jagged boundaries. The rendered image 111 may be smoothed through supersampling.

The image processing apparatus 100 may use change-data 112 to perform the reconstruction operation 120. For example, the change-data 112 may include a motion vector of each pixel of spatial data (e.g., corresponding to the rendered image 111). For example, the change-data 112 may include k^{th} change-data, where k refers to a frame number. The rendered image 111 may be a k−1^{th} frame image and a k^{th} frame image (at different respective times). The k^{th} change-data may include motion vectors according to a difference between pixels corresponding to the k−1^{th} frame image and related pixels corresponding to the k^{th} frame image.

The image processing apparatus 100 may use the change-data 112 to warp target data. For example, the target data may include an image, a filter kernel, and/or feature data. Through warping, pixels corresponding to the same object or feature in a target data pair of different viewpoints (e.g., time) may be aligned with each other. For example, the k^{th} change-data (of the change-data 112) may be determined by a difference between the k−1^{th} frame image and the k^{th} frame image of the rendered image 111, a k−1^{th} reconstruction result of the reconstruction result 121 may be determined by the k−1^{th} frame image, and warping the k−1^{th} reconstruction result may be performed by using the k^{th} change-data, to generate an aligned warping result on the k^{th} reconstruction result.

The image processing apparatus 100 may perform the reconstruction operation 120 using a neural network model. The neural network may be a deep neural network (DNN) including layers. The layers may include an input layer, at least one hidden layer, and an output layer. The hidden layer may be also referred to as an intermediate layer, and the output layer may be also referred to as a final layer.

The DNN may include, for example, one or more of a fully connected network (FCN), a convolutional neural network (CNN), a recurrent neural network (RNN), or the like. For example, at least some of the layers in the neural network may be a CNN and the others may be a FCN. In this case, the CNN may be referred to as convolutional layers and the FCN may be referred to as fully connected layers.

In the CNN, data input to any given layer may be referred to as an input feature map and data output from any given layer may be referred to as an output feature map. Input feature maps and the output feature maps may also be referred to as feature representations or activation data (or activation maps). With regard to a layer of a convolutional layer that corresponds to an input layer (e.g., a first layer), the input feature map of the input layer may be an input image (i.e., an input image may also be considered to be a feature map of sorts).

The neural network may be trained for a purpose based on deep learning and, so-trained, may perform inference for the training purpose by mapping input data and output data that are in a nonlinear relationship to each other. Deep learning is a machine learning technique for solving a problem, such as recognizing image or speech data in a big data set. Deep learning may involve solving an optimization problem of, for example, finding a point at which energy is minimized while training a neural network using prepared training data.

Through supervised or unsupervised deep learning, a structure or weight of the neural network model may be adjusted and the input data and the output data may be mapped to each other through the weight. If the width and the depth of the neural network are sufficient, the neural network may have a capacity to implement a predetermined function. The neural network may achieve an optimal performance by learning a sufficiently large amount of training data through an appropriate training process, and such parameters will for different applications, systems, and circumstances.

In the following, the neural network may be represented as being trained “in advance”. Here, being trained “in advance” means being trained before the neural network starts. That the neural network starts means that the neural network is ready for inference. For example, starting the neural network may include loading of the neural network in a memory or providing an input of data for inference to the neural network after the neural network is loaded in a memory.

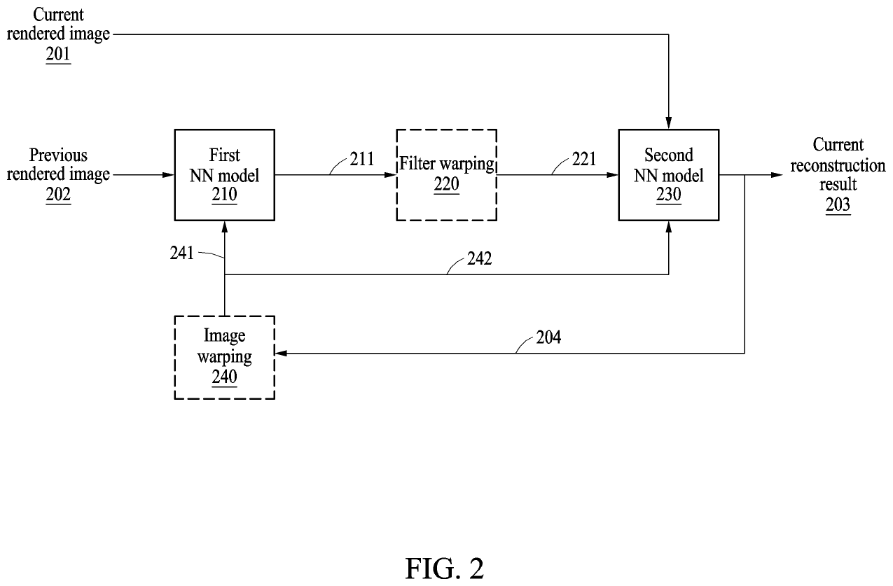

FIG. 2 illustrates an example of image reconstruction operations using a neural network model, according to one or more embodiments. Referring to FIG. 2, an image processing apparatus may generate a reconstruction image of a rendered image by using a first neural network model 210 and a second neural network model 230. The first neural network model 210 may be a filter generation model that generates, from the input image, a filter kernel for performing reconstruction for the input image, and the second neural network model 230 may be a filter application model that applies, to the input image, the filter kernel generated by the first neural network model 210 so as to generate a reconstruction result.

The image processing apparatus may use a current rendered image 201, a previous rendered image 202, and a previous reconstruction result 204 for generating the current rendered image 201. A current time is indicated by k, and an image of the current time is indicated as a k^{th} image. The current rendered image 201 may correspond to a k time (e.g., among time slots), and the previous rendered image 202 may correspond to a k−1 time. The previous reconstruction result 204 may, depending on the current time, be a first previous reconstruction result reconstructed from the previous rendered image 202 (which may be referred to as a first previous rendered image) at the k−1 time, or may be a second previous reconstruction result reconstructed from a second previous rendered image at the k−2 time.

The image processing apparatus may determine an image warping result 241 by performing an image warping operation 240 on the previous reconstruction result 204. The image warping result 241 may be determined by the second previous reconstruction result, and the image warping result 242 may be determined by the first previous reconstruction result. The image processing apparatus may warp the second reconstruction result reconstructed from a second rendered image by using first change-data according to a difference between the first previous rendered image (e.g., the previous rendered image 202) and the second previous rendered image, so as to determine the image warping result 241. The image processing apparatus may warp the first previous reconstruction result reconstructed from the first previous rendered image by using current change-data according to a difference between the current rendered image 201 and the first previous rendered image.

The image processing apparatus may execute the first neural network model 210 based on the previous rendered image 202 and the image warping result 241 to determine a previous filter kernel 211. The previous filter kernel 211 may correspond to a filter kernel corresponding to the k−1 time. The image processing apparatus may estimate a current filter kernel 221 (corresponding to the previous filter kernel 211) based on a filter warping operation 220. The image processing apparatus may warp the previous filter kernel 211 (using the current change-data) according to a difference between the current rendered image 201 and the first previous rendered image (e.g., the previous rendered image 202) in order to estimate the current filter kernel 221. The current filter kernel 221 may be a filter kernel corresponding to the k time. The current filter kernel 221 may be an estimation result obtained by warping an output of the first neural network model 210, rather than being a direct output of the first neural network model 210.

The image processing apparatus may execute the second neural network model 230 with the current rendered image 201 (as an input thereto), the current filter kernel 221 (as a filter thereof), and the image warping result 242 (as another input thereto) so as to determine a current reconstruction result 203. As described below, the estimation of a filter kernel through the filter warping operation 220 may enable distributed processing of operations related to the first neural network model 210 and of operations related to the second neural network model 230. The distributed processing may increase the speed of image reconstruction.

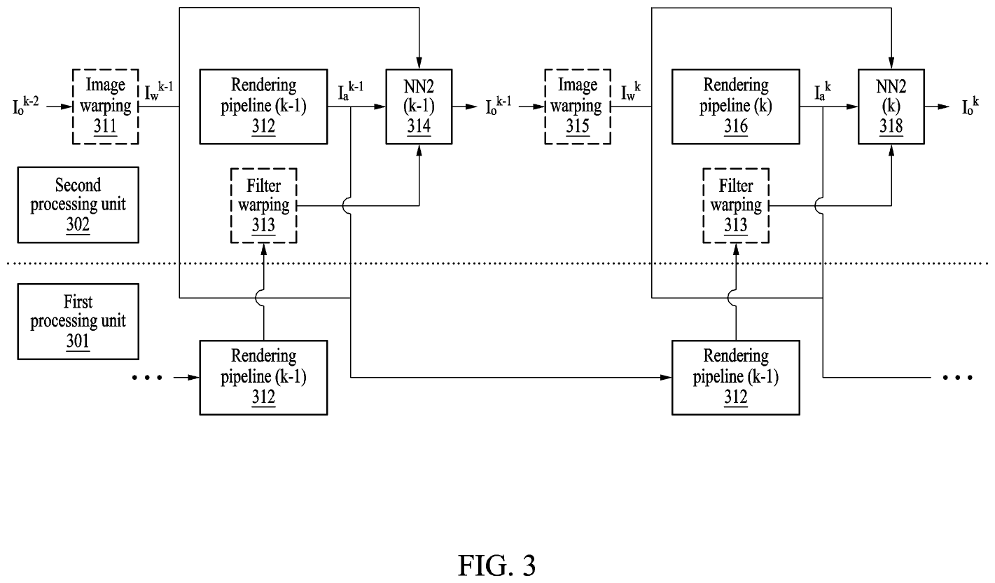

FIG. 3 illustrates an example of distributed processing of processing units, according to one embodiment. Referring to FIG. 3, distributed processing of image reconstruction may be performed by a first processing unit 301 and a second processing unit 302. Image reconstruction may be performed according to Equations 1 and 2 below.

$${I}_{w}^{k} = W ( {I}_{O}^{k - 1} , {I}_{v}^{k} ) \qquad Equation 1$$

$${I}_{O}^{k} = {U}_{f} ( W ( {U}_{g} ( {I}_{a}^{k - 1} , {I}_{w}^{k - 1} ) , {I}_{v}^{k} ) , {I}_{a}^{k} , {I}_{w}^{k} ) \qquad Equation 2$$

In Equations 1 and 2, U_{g} denotes a first neural network model (e.g., the first neural network model 210 and the filter generation model of FIG. 2), U_{f} denotes a second neural network model (e.g., the second neural network model 230 and the filter application model of FIG. 2), Iₒ^{k} denotes a reconstruction result, Iₐ^{k} denotes a rendered image, I_{w}^{k} denotes a warping result for a previous reconstruction result, Iᵥ^{k} denotes change-data (e.g., a two-dimensional grid of motion vectors), W denotes a warping calculation (e.g., a bilinear warping function), and k denotes a frame number.

The first processing unit 301 may generate a k−2^{nd} filter kernel through execution of the first neural network model. The first processing unit 301 performs the execution of the first neural network model based on the warping result I_{w}^{k-2} and the rendered image Iₐ^{k-2}. The k−1^{th} filter kernel may be estimated through a filter warping operation 313 based on the k−2^{nd} filter kernel and the warping result I_{w}^{k-1} may be generated through an image warping operation 311. The second processing unit 302 may generate the rendered image Iₐ^{k-1} through a rendering pipeline 312 at the k−1 time. The first processing unit 302 performs execution operation 314 of the second neural network model based on the warping result I_{w}^{k-1}, the rendered image Iₐ^{k-1}, and the k−1^{th} filter kernel, and thereby determines the reconstruction result Iₒ^{k-1}.

The first processing unit 301 may perform an execution operation 322 of the first neural network model based on the warping result I_{w}^{k-1} and the rendered image Iₐ^{k-1}, and thereby generates the k−1^{th} filter kernel. The k^{th} filter kernel may be estimated by a filter warping operation 317 based on the k−1^{th} filter kernel, and the warping result I_{w}^{k} may be generated by an image warping operation 315 according to the reconstruction result Iₒ^{k-1}. The second processing unit 302 may generate the rendered image Iₐ^{k} through a rendering pipeline 316 at the k time. The first processing unit 302 may perform an execution operation 318 of the second neural network model based on the warping result I_{w}^{k}, the rendered image Iₐ^{k}, and the k^{th} filter kernel, and thereby determines the reconstruction result Iₒ^{k}.

At least some of the image warping operations 311 and 315 and the filter warping operations 313 and 317 may be performed by the second processing unit 302, the first processing unit 301, or a processing unit other than the first processing unit 301 and the second processing unit 302.

The filter generation of the first neural network model and the filter application of the second neural network model may be temporally dependent on each other (i.e., they may have a time dependency). An estimation function of the filter warping operation 317 may provide a feature (temporally independent from another feature) to the filter generation of the first neural network model and to the filter application of the second neural network model. For example, in the case of no filter warping operation 317, since the first neural network model is required to determine the k^{th} filter kernel based on the reconstruction result Iₒ^{k-1}, the first neural network model and the second neural network model may be executed after the reconstruction result Iₒ^{k-1} is determined. The first processing unit 301 may execute the first neural network model on the basis of the reconstruction result Iₒ^{k-2}, independently from whether the reconstruction result Iₒ^{k-1} is generated or not, so as to generate the k−1^{th} filter kernel.

In addition, as shown in FIG. 3, the execution of the first neural network model may be independent from generating the rendered image Iₐ^{k} through the rendering pipeline 316. Accordingly, for example, the time of generating the rendered image Iₐ^{k} through the rendering pipeline 316 may at least partially overlap with the time of executing the first neural network model.

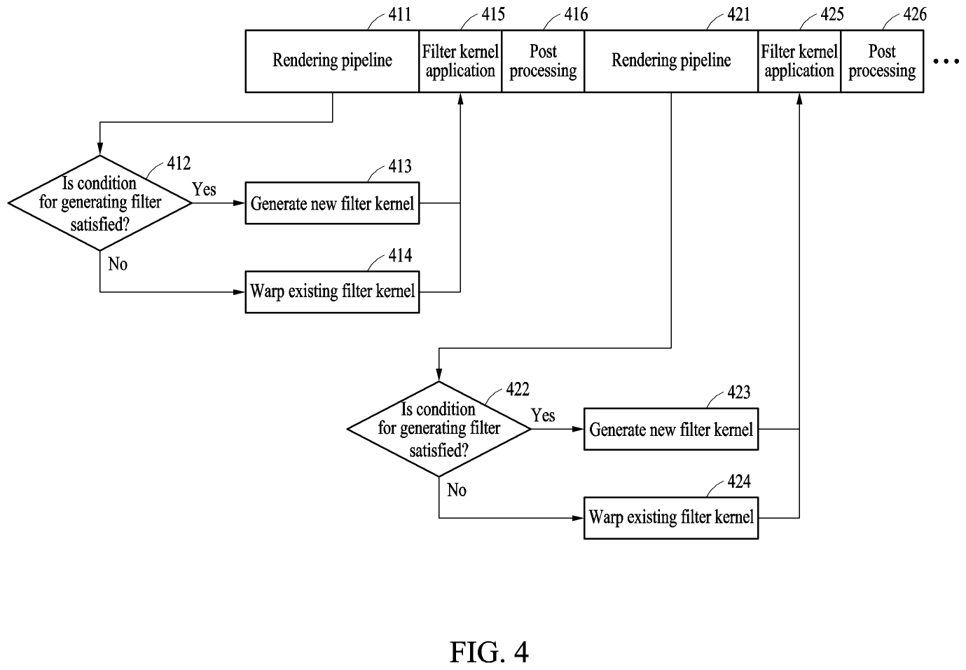

FIG. 4 illustrates an example of operations related to conditional generation of a filter kernel, according to one or more embodiments. Referring to FIG. 4, an image processing apparatus may operate a rendering pipeline to generate a rendered image in operation 411, a filter kernel may be determined by using a first neural network model in operations 412 to 414, the filter kernel may be applied to the rendered image by using a second neural network model in operation 415, and post processing (e.g., post rendering), if any, may be performed in operation 416. Operations 421 to 426 may be a repetition of operations 411 to 416 for a next image frame. In other words, they may be the same operations but may be performed with different data.

A filter generation operation may use more computing resources, such as calculations, memory space, and data transfer, compared to a warping operation or an operation of applying a filter (e.g., a convolution operation). This is because much computing resources may be required to execute the first neural network model. The image processing apparatus may minimize the number of times the filter generation operation is performed by using an estimation function of filter warping.

The image processing apparatus may check whether a condition for generating a filter is satisfied in operation 412, generate a new filter kernel in operation 413 when the condition is satisfied, and warp an existing filter kernel in operation 414 when the condition is not satisfied. Change-data according to a current time may be used for the filter warping. For example, where operation 414 corresponds to a k time and operation 424 corresponds to a k+1 time, k^{th} change-data may be used in operation 414 and k+1^{th} change-data may be used in operation 424. Accordingly, a filter kernel suitable for each current time may be estimated.

The condition for determining whether to generate the filter may be variously defined, for example, the condition may be whether a predetermined generation cycle (e.g., 4 frames) is satisfied, whether a difference (e.g., mean squared error (MSE)) between a current image warping result and a recent image warping result (e.g., the previous image warping result) exceeds a threshold, whether a motion change (e.g., a cumulative motion change) exceeds a threshold (e.g. whether the average of the cumulative motion change exceeds 4 pixels), or whether a motion of a camera (e.g., cumulative motion) exceeds a threshold.

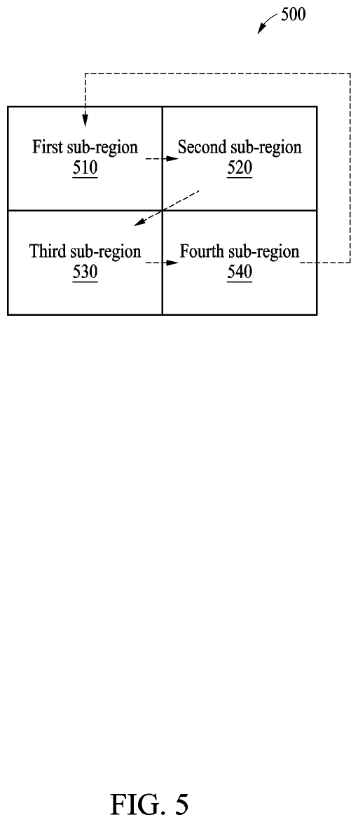

FIG. 5 illustrates an example of a partial update of a filter kernel, according to one or more embodiments. An image processing apparatus may minimize an area in which a filter generation operation is performed by using an estimation function of filter warping. For example, when the condition for generating a filter is not satisfied, the image processing apparatus may determine a partial filter kernel of a target region of a filter kernel 500 by executing a first neural network model and may update a region corresponding to the filter kernel 500 as a partial filter kernel.

The filter kernel 500 may include sub-regions 510 to 540. The target region may be sequentially selected from among the sub-regions 510 to 540 according to the passage of time. For example, the first sub-region 510, the second sub-region 520, the third sub-region 530, and the fourth sub-region 540 may be selected in this order at different times. Alternatively, the sub-regions 510 to 540 may be selected in a different order and may be selected arbitrarily without a special order.

For example, where a k^{th} filter kernel is estimated, the image processing apparatus may execute a first neural network model based on a k−1^{th} rendered image and a k−1^{th} image warping result to determine a target region of the k−1^{th} filter kernel, update a region corresponding to an existing kernel used prior to the k−1^{th} kernel (e.g., the k−2^{nd} filter kernel) as a partial filter kernel of the k−1^{th} filter kernel, and estimate a k^{th} filter kernel by warping the k−1^{th} filter kernel.

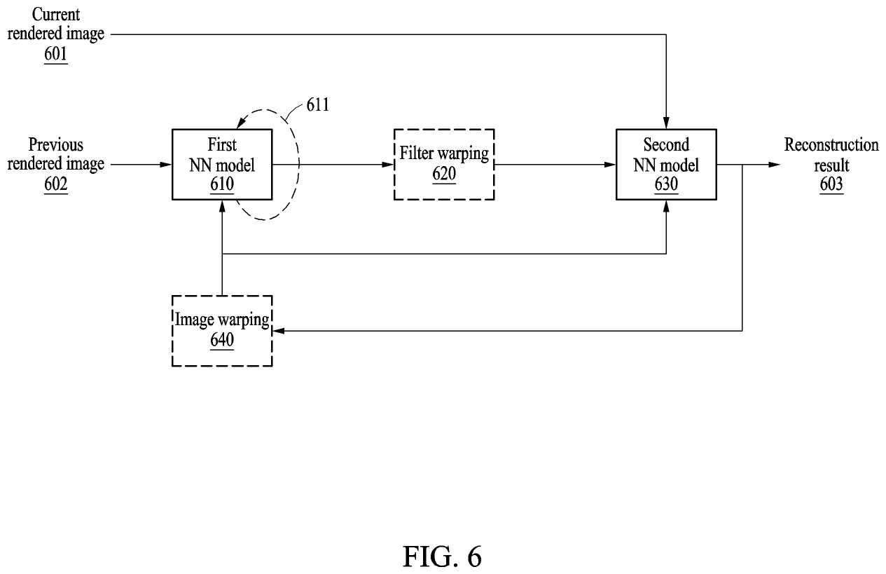

FIG. 6 illustrates an example of image reconstruction operations using a first neural network model including a convolutional recurrent layer, according to one or more embodiments. Referring to FIG. 6, an image processing apparatus may execute a first neural network model 610 and a second neural network model 630 based on a current rendered image 601 and based on a previous rendered image 602, and may define a reconstruction result 603 by performing a filter warping operation 620 and an image warping operation 640. The first network model 610 may include a convolutional recurrent layer 611. The convolutional recurrent layer 611 may determine a current feature based on a feature from a previous layer. In this case, the convolutional recurrent layer 611 may warp the previous feature using the change-data and may determine the current feature based on a warping result. Such an operation of warping the feature may improve an image reconstruction performance by appropriately estimating the motion of an object.

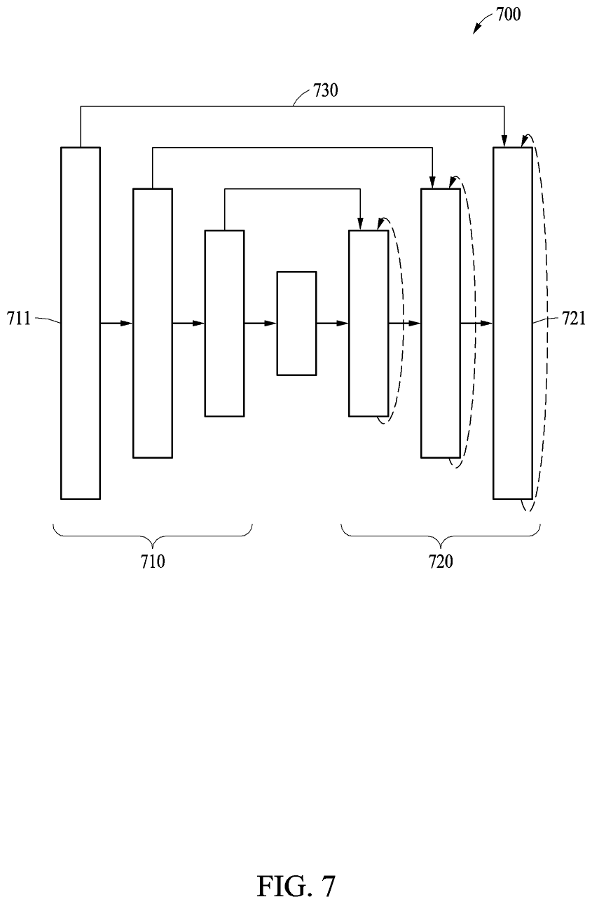

FIG. 7 illustrates an example of a neural network model, according to one or more embodiments. Referring to FIG. 7, a first neural network model 700 may include an encoding block 710, a decoding block 720, and a skip connection 730. For example, the first neural network model 700 may correspond to an auto encoder. The encoding block 710 may include a convolutional layer 711, and the decoding block 720 may include a convolutional recurrent layer 721. The convolutional recurrent layer 721 may be executed based on the operation of warping the feature.

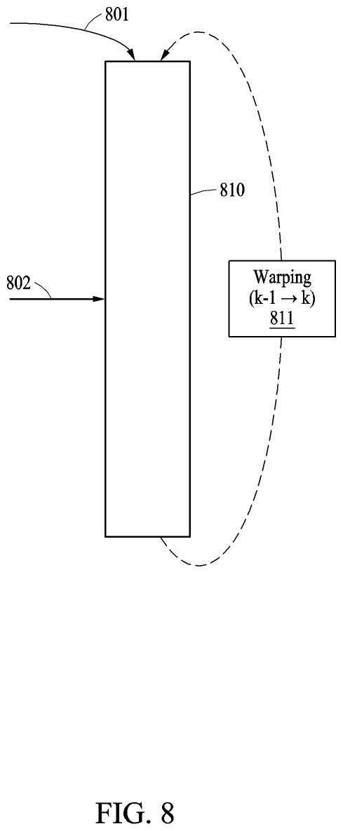

FIG. 8 illustrates an example of an operation of a recurrent layer, according to one or more embodiments. Referring to FIG. 8, an input 801 from an encoding block through a skip connection, an input 802 from a previous layer, and a warping result according to a warping operation 811 may be provided to a convolutional current layer 810. The warping operation 811 may estimate a k^{th} feature according to a k−1^{th} feature of the convolutional recurrent layer 810. Change-data (e.g., the k^{th} change-data) may be used for the warping operation 811.

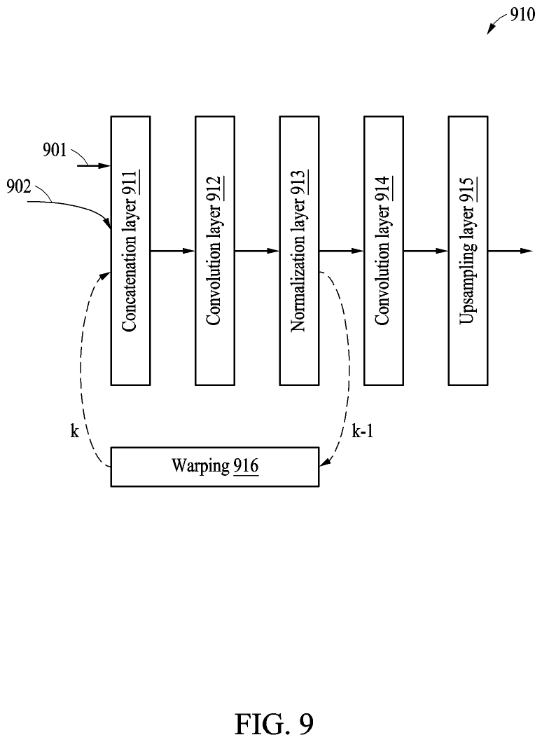

FIG. 9 illustrates an example configuration of a recurrent layer, according to one or more embodiments. Referring to FIG. 9, a convolutional recurrent layer 910 may include a concatenation layer 911, a convolution layer 912, a normalization layer 913, a convolution layer 914, and an upsampling layer 915. For example, the normalization layer 913 may perform normalization and the upsampling layer 915 may perform bilinear upsampling. An input 901 through a skip connection from an encoding block and an input 902 from a previous layer may be provided to the convolutional recurrent layer 910.

A current feature according to a previous feature may be estimated by a warping operation 916. The output of the normalization layer 913 may be warped to the previous feature, and a warping result may be provided to the concatenation layer 911 as the current feature. Change-data (e.g., the k^{th} change-data) may be used for the warping operation 916. The warping operation 916 may improve image reconstruction performance by appropriately predicting a motion of an object.

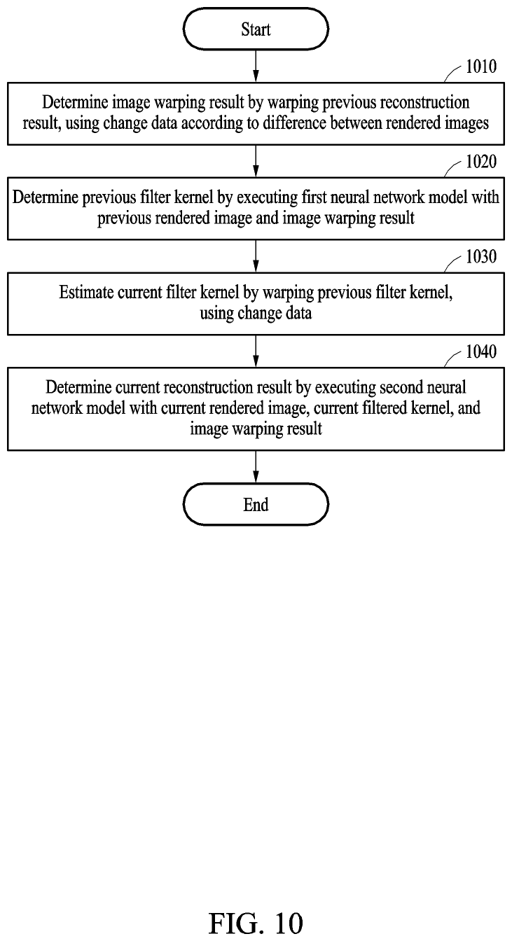

FIG. 10 illustrates an example of an image processing method, according to one or more embodiments. Referring to FIG. 10, an image processing apparatus may warp a previous reconstruction result using change-data according to a difference between rendered images to determine an image warping result in operation 1010, may execute a first neural network model with a previous rendered image and the image warping result to determine a previous filter kernel in operation 1020, may warp the previous filter kernel by using the change-data to estimate a current filter kernel in operation 1030, and may execute a second neural network model with the current rendered image, the current filter kernel, and the image warping result, and may thus determine a current reconstruction result in operation 1040.

Operation 1010 may further include determining a first image warping result by warping a second previous reconstruction result reconstructed from a second previous rendered image, using first change-data according to a difference between the first previous rendered image and the second previous rendered image, and may further include determining a current image warping result by warping a first previous reconstruction result reconstructed from the first previous rendered image, using current change-data according to a difference between the current rendered image and the first previous rendered image. The first previous rendered image may correspond to a previous frame of the current rendered image, and the second previous rendered image may correspond to a previous frame of the first previous rendered image.

Operation 1020 may include executing the first neural network model with the previous rendered image and the first image warping result. Operation 1040 may include executing the second neural network model with the current rendered image, the current filter kernel, and the current image warping result.

Operation 1020 may be performed by a first processing unit, and operation 1040 may be performed by a second processing unit. Operations 1010 and 1030 may be further performed by the first processing unit.

The first processing unit may determine the previous filter kernel by executing the first neural network model, independent of whether the current rendered image is generated. The previous rendered image may be, at different times, a first previous rendered image corresponding to a previous frame of the current rendered image or a second previous rendered image corresponding to the previous frame of the first previous rendered image. The previous reconstruction result may be, depending on the time, a first previous reconstruction result reconstructed from the first previous rendered image or a second previous reconstruction result reconstructed from the second previous rendered image. To determine a previous filter kernel, the first processing unit may execute the first neural network model based on the previous rendered image and the second previous reconstruction result, and may do so independent of whether the current rendered image and the first previous reconstruction result are generated.

When a condition for generating a filter is not satisfied, determining the previous filter kernel may be omitted (not performed). Operation 1030 may include warping, instead of the previous filter kernel, an existing filter kernel used prior to the previous filter kernel to estimate the current filter kernel.

When the condition for generating the filter is not satisfied, operation 1020 may include determining a partial filter kernel of a target region of a previous filter kernel by executing the first neural network model with the previous rendered image and the image warping result. Operation 1030 may include updating, as the partial filter kernel of the previous filter kernel, a region corresponding to the existing filter kernel used prior to the previous kernel to estimate the current filter kernel.

The previous filter kernel may include sub-regions, and the target region may be sequentially selected from the sub-regions.

The first neural network model may correspond to an auto-encoder model including an encoding block and a decoding block. The decoding block may include a convolutional recurrent layer that determines a current feature based on a previous feature. The convolutional recurrent layer may warp the previous feature using change-data and determine the current feature based on a warping result.

In addition, the description provided with reference to FIGS. 1 to 9 and 11 to 12 may apply to the image reconstruction method of FIG. 10.

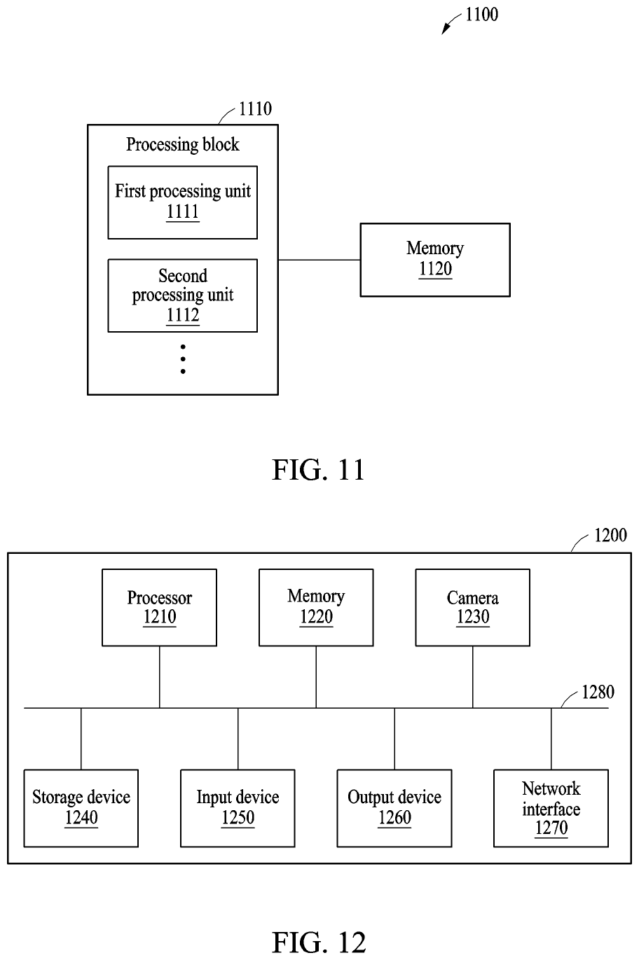

FIG. 11 illustrates an example configuration of an image reconstruction apparatus, according to one or more embodiments. Referring to FIG. 11, an image processing apparatus 1100 may include a processing block 1110 and a memory 1120. The processing block 1110 may include a first processing unit 1111 and a second processing unit 1112. The processing block 1110 may further include additional processing units other than the first processing unit 1111 and the second processing unit 1112.

The memory 1120 may be connected to the processing block 1110 and may store instructions executable by the processing block 1110, data to be calculated by the processing block 1110, or data processed by the processing block 1110. The memory 1120 includes a non-transitory computer readable medium, for example, a high-speed random access memory, and/or a non-volatile computer readable storage medium, for example, at least one disk storage device, flash memory device, or other non-volatile solid state memory devices.

The processing block 1110 may execute the instructions to perform operations described above with reference to FIGS. 1 to 10 and 12. For example, the first processing unit 1111 may determine an image warping result by warping a previous reconstruction result using change-data according to a difference between rendered images. The second processing unit 1112 may determine a previous filter kernel by executing the first neural network model, based on the previous rendered image and the image warping result. The first processing unit 1111 may warp the previous filter kernel by using the change-data to estimate the current filter kernel and may execute the second neural network model with the current rendered image, the current filter kernel, and the image warping result to determine a current reconstruction result.

The previous rendered image may be a first previous rendered image corresponding to a previous frame of the current rendered image or a second previous rendered image corresponding to a previous frame of the first previous rendered image. The previous reconstruction result may be a first previous reconstruction result reconstructed from the first previous rendered image or a second previous reconstruction result reconstructed from the second previous rendered image. The first processing unit 1111 may determine the previous filter kernel by executing the first neural network model with the previous rendered image and the second previous construction result, and may do so independent of whether the current rendered image and the first previous reconstruction result are generated.

Where a condition for generating a filter is not satisfied, the second processing unit 1112 may omit determining the previous filter kernel and the first processing unit 1111 may warp, instead of the previous filter kernel, an existing filter kernel used prior to the previous filter kernel, to estimate the current filter kernel.

The first neural network model may correspond to an auto-encoder model including an encoding block and a decoding block, and the decoding block may include a convolutional recurrent layer that determines a current feature, based on a previous feature. The convolutional recurrent layer may warp the previous feature using change-data and may determine the current feature based on a warping result.

In addition, the description provided with reference to FIGS. 1 to 10 and 12 may apply to the image processing apparatus 1100.

FIG. 12 illustrates an example configuration of an electronic device, according to one or more embodiments. Referring to FIG. 12, an electronic device 1200 may include a processor 1210, a memory 1220, a camera 1230, a storage device 1240, an input device 1250, an output device 1260, and a network interface 1270 that may communicate with each other through a communication bus 1280. The processor 1210 may be one or more types of processors. For example, the electronic device 1200 may be implemented as at least a portion of, for example, a mobile device such as a mobile phone, a smart phone, a personal digital assistant (PDA), a netbook, a tablet computer, a laptop computer, and the like, a wearable device, such as a smart watch, a smart band, smart glasses, and the like, a home appliance, such as a television (TV), a smart TV, a refrigerator, and the like, a security device, such as a door lock and the like, and a vehicle, such as an autonomous vehicle, a smart vehicle, and the like. The electronic device 1200 may structurally and/or functionally include the image processing apparatus 100 of FIG. 1 and/or the image processing apparatus 1100 of FIG. 11.

The processor 1210 executes instructions or functions to be executed by the electronic device 1200. For example, the processor 1210 may process the instructions stored in the memory 1220 or the storage device 1240. The processor 1210 may perform the one or more operations described with reference to FIGS. 1 to 11. The memory 1220 may include a computer-readable storage medium or a computer-readable storage device. The memory 1220 may store instructions to be executed by the processor 1210 and may store related information while software and/or an application is executed by the electronic device 1200.

The camera 1230 may capture a photo and/or a video (for example, any of the frames discussed above). The storage device 1240 includes a computer-readable storage medium or computer-readable storage device. The storage device 1240 may store a greater quantity of information than the memory 1220 for a long time. For example, the storage device 1240 may include a magnetic hard disk, an optical disc, a flash memory, a floppy disk, or other non-volatile memories known in the art.

The input device 1250 may receive an input from the user in traditional input manners through a keyboard and a mouse and in new input manners, such as a touch input, a voice input, and an image input. For example, the input device 1250 may include a keyboard, a mouse, a touch screen, a microphone, or any other device that detects the input from the user and transmits the detected input to the electronic device 1200. The output device 1260 may provide an output of the electronic device 1200 to the user through a visual, auditory, or haptic channel. The output device 1260 may include, for example, a display, a touch screen, a speaker, a vibration generator, or any other device that provides the output to the user. The network interface 1270 may communicate with an external device through a wired or wireless network.

The examples described herein may be implemented using a hardware component, a software component, and/or a combination thereof. A processing device may be implemented using one or more general-purpose or special-purpose computers, such as, for example, a processor, a controller, and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The computing apparatuses, the electronic devices, the processors, the memories, the image sensors, the displays, the information output system and hardware, the storage devices, and other apparatuses, devices, units, modules, and components described herein with respect to FIGS. 1-12 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-12 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An image reconstruction method comprising:
determining an image warping result by warping a previous reconstruction result using change-data corresponding to a difference between rendered images;
determining a previous filter kernel by executing a first neural network model with a previous rendered image and the image warping result;
estimating a current filter kernel by warping the previous filter kernel using the change-data; and
determining a current reconstruction result by executing a second neural network model with a current rendered image, the current filter kernel, and the image warping result.

2. The image reconstruction method of claim 1, wherein the determining of the image warping result comprises:
determining a first image warping result by warping a second previous reconstruction result reconstructed from a second previous rendered image using first change-data corresponding to a difference between a first previous rendered image and the second previous rendered image; and
determining a current image warping result by warping a first previous reconstruction result reconstructed from the first previous rendered image using current change-data corresponding to a difference between a current rendered image and the first previous rendered image,
wherein the first previous rendered image corresponds to a previous frame of the current rendered image and the second previous rendered image corresponds to a previous frame of the first previous rendered image.

3. The image reconstruction method of claim 2, wherein the determining of the previous filter kernel comprises executing the first neural network model with the previous rendered image and the first image warping result.

4. The image reconstruction method of claim 2, wherein the determining of the current reconstruction result comprises executing the second neural network model with the current rendered image, the current filter kernel, and the current image warping result.

5. The image reconstruction method of claim 1, wherein
the determining of the previous filter kernel by executing the first neural network model is performed by a first processing unit, and
the determining of the current reconstruction result by executing the second neural network model is performed by a second processing unit.

6. The image reconstruction method of claim 5, wherein the determining of the image warping result and the estimating of the current filter kernel are further performed by the first processing unit.

7. The image reconstruction method of claim 5, wherein the first processing unit is configured to determine the previous filter kernel by executing the first neural network model independent of whether the current rendered image is generated.

8. The image reconstruction method of claim 5, wherein
the previous rendered image comprises a first previous rendered image corresponding to a previous frame of the current rendered image or a second previous rendered image corresponding to a previous frame of the first previous rendered image,
the previous reconstruction result comprises a first previous reconstruction result reconstructed from the first previous rendered image or a second previous reconstruction result reconstructed from the second previous rendered image, and
the first processing unit is configured to determine the previous filter kernel by executing the first neural network model based on the previous rendered image and the second previous reconstruction result, independent of whether the current rendered image and the first previous reconstruction result are generated.

9. The image reconstruction method of claim 1, wherein,
when a condition for generating a filter is not satisfied, the determining of the previous filter kernel is omitted, and wherein
the estimating of the current filter kernel comprises estimating the current filter kernel by warping an existing filter kernel used prior to the previous filter kernel, instead of warping the previous filter kernel.

10. The image reconstruction method of claim 1, wherein,
when a condition for generating a filter is not satisfied, the determining of the previous filter kernel comprises determining a partial filter kernel of a target region of the previous filter kernel by executing the first neural network model with the previous rendered image and the image warping result, and
the estimating of the current filter kernel comprises updating a region corresponding to an existing filter kernel used prior to the previous filter kernel as the partial filter kernel of the previous filter kernel, warping the existing filter kernel, and estimating the current filter kernel.

11. The image reconstruction method of claim 10, wherein the previous filter kernel comprises sub-regions, and the target region is sequentially selected from among the sub-regions.

12. The image reconstruction method of claim 1, wherein the first neural network model comprises an auto-encoder model comprising an encoding block and a decoding block.

13. The image reconstruction method of claim 12, wherein the decoding block comprises a convolutional recurrent layer configured to determine a current feature based on a previous feature.

14. The image reconstruction method of claim 13, wherein the convolutional recurrent layer warps the previous feature using the change-data and determines the current feature based on a warping result.

15. A non-transitory computer-readable storage medium storing instructions that, when executed by a processor, cause the processor to perform the method of claim 1.

16. An image processing apparatus comprising:
a first image processing unit configured to warp a previous reconstruction result using change-data according to a difference between rendered images, and configured to determine an image warping result; and
a second processing unit configured to determine a previous filter kernel by executing a first neural network model with a previous rendered image and the image warping result,
wherein the first processing unit is configured to estimate a current filter kernel by warping the previous filter kernel using the change-data, and is configured to determine a current reconstruction result by executing a second neural network model with a current rendered image, the current filter kernel, and the image warping result.

17. The image processing apparatus of claim 16, wherein
the previous rendered image comprises a first previous rendered image corresponding to a previous frame of the current rendered image or a second previous rendered image corresponding to a previous frame of the first previous rendered image,
the previous reconstruction result comprises a first previous reconstruction result reconstructed from the first previous rendered image or a second previous reconstruction result reconstructed from the second previous rendered image, and
the first processing unit is configured to determine the previous filter kernel by executing the first neural network model based on the previous rendered image and the second previous reconstruction result, independent of whether the current rendered image and the first previous reconstruction result are generated.

18. The image processing apparatus of claim 16, wherein,
when a condition for generating a filter is not satisfied, the second processing unit omits the determining of the previous filter kernel, and
the first processing unit estimates the current filter kernel by warping an existing filter kernel used prior to the previous filter kernel, instead of warping the previous filter kernel.

19. The image processing apparatus of claim 16, wherein
the first neural network model corresponds to an auto-encoder model comprising an encoding block and a decoding block, and
the decoding block comprises a convolutional recurrent layer configured to determine a current feature based on a previous feature.

20. The image processing apparatus of claim 19, wherein the convolutional recurrent layer is configured to warp the previous feature using the change-data, and is configured to determine the current feature based on a warping result.
